(19) United States
(12) Patent Application Publication
(10) Pub. No.: US 2005/0237910 A1
(43) Pub. Date: Oct. 27, 2005

(54) Optical data storage medium and use of such medium

(75) Inventor: Hubert Cecile Francois Martens, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijike Philips Electronics N.V., Groenewoudseweg 1 (NL)

(21) Appl. No.: 10/509,454

(22) PCT Filed: Apr. 1, 2003
(86) PCT No.: PCT/IB03/01377

§ 371 Date: Sep. 28, 2004

(30) Foreign Application Priority Data
Apr. 2, 2002 (EP) 02076286.0

(51) Int. Cl. G11B 7/24

(52) U.S. Cl. 369/275.4

(57) ABSTRACT

An optical data storage medium (10) for recording by means of a focused radiation beam (9) having a wavelength λ is described. The beam enters through an entrance face (8) of the medium during recording. The medium at least comprises a substrate (1), including a guide groove with a depth g. The guide groove is present at the side of the substrate opposite to the entrance face. A recording stack (2, 3) of layers is present adjacent the substrate (1) at the side of the guide groove. The stack includes a write once recording layer (2) of a material having a complex refractive index ñ_{R}=n_{R}−i*k_{R} at the wavelength λ and having a thickness d_{RG} in the groove portion and a thickness d_{RL} in the portion between grooves. A non-metallic layer (3) of a substantially transparent material, is present adjacent the write-once recording layer (2). The groove depth g is in the range (λ/655)*20 nm<g<(λ/655)*140 nm with λ expressed in nm. This range achieves a sufficient push-pull tracking signal and a sufficient modulation of recorded marks.

The invention relates to an optical data storage medium for recording by means of a focused radiation beam having a wavelength λ and entering through an entrance face of the medium during recording, at least comprising:
a substrate, including a guide groove with a depth g, the guide groove being present at the side of the substrate opposite to the entrance face,
a recording stack of layers on the substrate at the side of the guide groove, which stack includes:
a write once recording layer of a material having a complex refractive index ñ_{R}=n_{R}−i*k_{R} at the wavelength λ and having a thickness d_{RG} in the groove portion and a thickness d_{RL} in the portion between grooves, being present adjacent the substrate,
a non-metallic layer of a substantially transparent material, being present adjacent the write-once recording layer.

The invention also relates to the use of such an optical data storage medium in a standard optical data storage medium reading/recording device.

One of the driving factors in the optical data storage field is the increment of the data capacity. At present a dual stack Digital Versatile Disk Recordable medium (DL-DVD+R) is being developed, which will increase data storage capacity by almost a factor two on a 12 cm DVD recordable disk: 8.5 GB on dual-layer DVD+R compared to 4.7 GB on a single layer DVD+R. A further doubling of data storage capacity can be gained by moving to quadruple-stack DVD recordable disks (QL-DVD+R). Most likely, such a quadruple-stack medium will also be based on reflective storage layers. Switchable layers, e.g. thermochromic, photochromic, or electrochromic, are less likely to be considered at present. Note that the term stack is often referred to as layer, although a stack comprises two or more layers. The terms medium and disk are used interchangably.

In case of dual-stack DVD+R disk it has been recognized that dyes are the most attractive candidates as recording material due to their intrinsic high transparency at the recording/reading wavelength. Therefore, also for multi-stack disks dyes will be used as the recording material. Most likely, for the deepest stack a conventional DVD+R stack design can be used. Multi-stack designs may be represented by a symbol Ln in which n denotes 0 or a positive integer number. The stack at which the radiation beam arrives first, i.e. the stack closest to the entrance face, is called L0, while each stack further from the radiation source is represented by L1 . . . Ln. Thus in case of dual stack media two stacks L0 and L1 are present in which design L0 denotes the “top” recording layer and L1 denotes the “deepest” recording layer. The L0 stack in a dual-stack DVD+R may use a thin semi transparent metallic reflective layer, e.g. a 10 nm Ag layer. Such an L0 stack has a transmission of about 60%. However, in QL-DVD+R disks, further L2 and L3 stacks are present and the L0 and L1 stacks require even higher transmission values of 70-80% in order to achieve sufficient signal from the deeper L2 and L3 stacks. Increasing the transmission by using even thinner metallic layers is not an option because layer homogeneity becomes problematic. However, high-transparency stacks can be obtained by combining dyes with non-metallic reflective layers, e.g. dielectric mirrors, which are known in the art.

For truly useful stack designs, several parameters must be simultaneously optimized: reflection and transmission, modulation of written marks and servo tracking signal for each of the stacks.

To be able to track an empty recordable optical disk (either single-stack, dual-stack, or multi-stack), so-called guide grooves or pre-grooves are present in the substrate or intermediate layer on which the optical recording stack is deposited. The pre-grooves result in a phase-difference between light reflected from the grooves and light reflected from the portion in between the grooves (lands). As a consequence of the different complex reflection amplitudes on land and groove, the incoming radiation beam, e.g. laser-light, is diffracted. When detected properly, the interference between the ±1st and 0th diffracted orders of the reflected light results in the so-called push-pull signal which can be used by an optical tracking system to keep the laser-light spot on the pre-grooves. In practice this method employs two radiation-sensitive detectors arranged in the path of the beam that has been reflected from the optical data storage medium so that the detectors receive radially different portions of the reflected beam. The difference between the output signals of the two detectors contains information about the radial position of the laser spot relative to the groove. If the output signals are equal, the center of the laser spot coincides with the center of the groove or the center between two adjacent grooves. Hence during recording the groove is employed for detecting the radial position of the laser light write spot formed on the recording layer by the focused laser beam, relative to a groove, so that the radial position of the write spot can be corrected. As a result of this, less stringent requirements have to be imposed on the drive and guide mechanism for moving the write beam and the optical data storage medium relative to each other, enabling a simpler and cheaper construction to be used for the write apparatus. In order for an optical drive to track properly on an empty disk, it is essential that the push-pull signal has both the correct sign and a sufficient value. The required values are usually specified in the standard of the specific optical disk. In general, both the sign and amplitude of the push-pull signal are to a large extent governed by the phase difference between light reflected from land and groove. Usually the guide groove or pregroove track comprises a spiral groove in the transparent substrate or intermediate layer and the recording layer is a thin layer of, for example, an organic dye. The guide groove extends across the entire optical data storage medium surface. The focused laser light beam, of sufficiently high intensity can produce an optically detectable change or mark in the recording layer. The modulation depth M of such written marks is defined as the difference in the light intensity received from an unwritten part of the groove and the light intensity from a written part of the groove normalized to the maximum of the two intensities.

It has been found that layers of specific dyes are very suitable for use as a recording layer on a pre-grooved optical data storage medium substrate. Such a dye may, for example, be a cyanine dye or an azo dye, which can be deposited by spincoating a solution of such a dye on the substrate surface. When a layer of dye is applied to a pre-grooved optical data storage medium substrate the grooves are filled partially or completely and the thickness of the layer at the location of the grooves d_{RG} will generally be larger than the thickness d_{RL} between the grooves. The area between the grooves is also called on-land. As a result of this difference in layer thickness, which is equal to the d_{RG}−d_{RL}, an additional phase shift occurs between the radiation reflected from the recording layer at the location of a groove and radiation reflected from the recording layer at the location of a land. This additional phase shift gives rise to a differential tracking signal which is different from the case in which d_{RG}=d_{RL}. A leveling parameter may defined as: L=(d_{RG}−d_{RL})/g. When L=1 the grooves are completely flattened out by the recording layer, that is the groove structure is not present anymore in the surface of the recording layer opposing the substrate. This may occur for very shallow grooves (g<<d_{RG}). However, in most practical cases, e.g. Compact Disk Recordable (CD-R) or DVD Recordable (DVD+R) disks, the leveling parameter L ranges from 0.2 to 0.5. For instance, for a typical DVD+R, the groove depth is 160 nm, the dye thickness in the groove is 100 nm and the dye thickness on-land is 40 nm: L=(100−40)/160=0.375. When the dye is deposited by a different technique such as evaporation the leveling can be nearly zero, i.e. the same thickness of dye on-land and in-groove.

It is an object of the present invention to provide an optical data storage medium of the kind described in the opening paragraph, which has a sufficient push-pull signal and a sufficient modulation of recorded marks.

This object is achieved in accordance with the invention by an optical data storage medium as described in the opening paragraph, which is characterized in that the groove depth g is in the range (λ/655)*20 nm<g<(λ/655)*140 nm with λ expressed in nm.

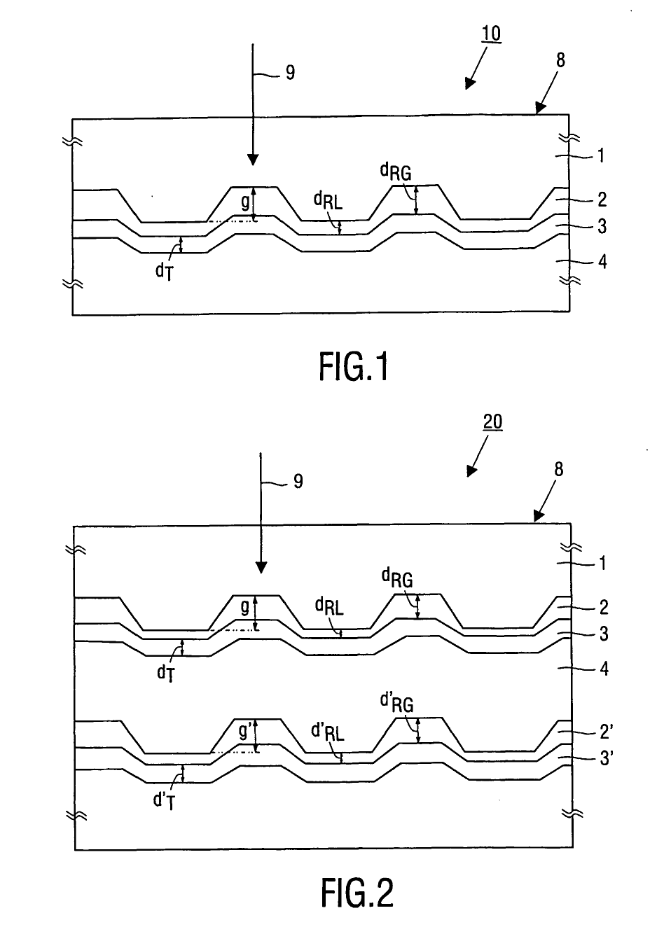

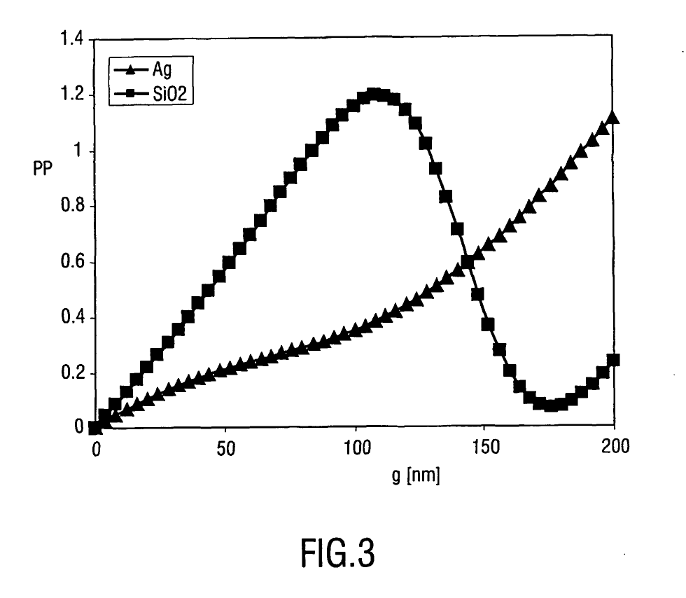

The invention is based on the recognition of the problem that for an optical storage medium according to the opening paragraph having a non-metallic reflective layer the value of the push-pull signal of the groove and the value of the mark modulation are not sufficient. As shown in FIG. 3 there is a substantial difference between the normalized push-pull signal PP (defined below) in case of a metallic and a non-metallic reflective layer. Even more important, for the typical groove depth of 170 nm used in single-layer DVD+R with metallic reflective layer, the push-pull in the case of dye-on-dielectric stack is nearly zero, which implies that tracking on such a disc is practically impossible. The guide groove, normally formed as a spiral, has a pitch p and preferably has an average width w in the range of 0.3 to 0.7 times p. For DVD the pitch p is approximately 0.74 μm. For DVD the wavelength λ is approximately 655 nm. For different wavelengths the optimum range needs to be scaled accordingly, e.g. for λ=405 nm multiply by 405/655. Hence the optimum range for λ=405 nm would be (405/655)*20 nm<g<(405/655)*140 nm. Generally the push-pull signal is derived by subtracting the signals I_{R} and I_{L} from the right and left detector halve of a split detector that is present in the reflected light path of the laser beam during scanning of the guide groove. In optical disk standard specifications the push-pull signal is normally defined as a normalized parameter PP=<I_{R}−I_{L}>/[I_{R}+I_{L}] in which formula <I_{R}−I_{L}> denotes the maximum difference of I_{R}−I_{L} and [I_{R}+I_{L}] denotes the average value of I_{R}+I_{L} when the laser spot moves radially outwards across the guide grooves. Note that this PP is not the same as the unnormalized push pull signal denoted by PP (in italics) which can be defined as (I_{R}−I_{L}). The shape of the graph of the normalized push-pull signal PP for a stack, including a non-metallic reflective layer, as a function of groove depth is considerably different from the case with a normal metallic reflective layer, which is shown in FIG. 3. A different track pitch and/or groove width may slightly influence the amplitude of the push-pull, but this effect is considerably smaller than the effect of groove depth. Normally the groove is shaped as shown in FIG. 1 in which drawing the definition of the groove depth is shown. According to the DVD+R standard, the phase depth of the grooves should not exceed 90 degrees, this means that in the presented calculations the push-pull of the normal stack should be positive.

The recognized problem outlined above can be solved by using the claimed range of groove depths in case of a non-metallic reflective layer compared to normal range of groove depths 150 nm to 180 nm for conventional disks having a metallic reflective layer. The advantage of this solution is that radial push-pull tracking on such a disk having a stack with a non-metallic reflective layer becomes possible and that furthermore the modulation of written marks is sufficient.

In an embodiment the non-metallic layer mainly comprises a material selected from the group of transparent plastic, silicon, oxides of silicon, nitrides of silicon and carbides of silicon.

These materials are suitable candidates because they have a relatively high transparency and are relatively stable. Other suitable dielectric materials are ZnS—SiO₂, and oxides and nitrides in general.

For λ=655 nm, e.g. used for DVD, it is preferred that 20 nm<g<125 nm. It is important for reliable readout that the modulation is maximized. In the groove depth range g>125 nm the modulation M drops to relatively small values. Therefore the said range of groove depth g for a non-metallic reflective layer recordable DVD-type stack is preferred.

For λ=655 nm, it is preferred that 50 nm<g<125 nm because for very shallow grooves the push-pull signal PP may become relatively too small which will result in unreliable tracking.

In an embodiment, in which λ=655 nm, the recording layer has a thickness d_{RG} and 145 nm≦d_{RG}*n_{R}<245 nm and the non-metallic layer mainly comprises SiO₂ and has a thickness d_{T} in the range 10 nm≦d_{T}≦120 nm. In the preferred embodiment with this non-metallic layer material the following approximate values apply: d_{T}=110 nm, d_{RG}=80 nm, g=80 nm, the dye is an azo dye with ñ_{R}=2.45−i*0.08 at the recording wavelength.

In another embodiment, in which λ=655 nm, the recording layer has a thickness d_{RG} and 132 nm≦d_{RG}*n_{R}<220 nm and the non-metallic layer mainly comprises SiC and has a thickness d_{T} in the range 10 nm≦d_{T}≦60 nm. In the preferred embodiment with this non-metallic layer material the following approximate values apply: d_{T}=52 nm, d_{RG}=70 nm, g=120 nm, the dye is an azo dye with ñ_{R}=2.24−i*0.02 at the recording wavelength.

In a further embodiment, in which λ=655 nm, the recording layer has a thickness d_{RG} and 154 nm≦d_{RG}*n_{R}<264 nm and the non-metallic layer mainly comprises amorphous Si (a-Si) and has a thickness d_{T} in the range 1 nm≦d_{T}≦20 nm. In the preferred embodiment with this non-metallic layer material the following approximate values apply: d_{T}=10 nm, d_{RG}=100 nm, g=120 nm, the dye is an azo dye with ñ_{R}=2.24−i*0.02 at the recording wavelength.

In another embodiment at least one further recording stack is present adjacent a further substrate, including a guide groove with a depth g. in the same range as g, the guide groove being present at the side of the further substrate opposite to the entrance face, the further recording stack including:
a further write once recording layer of a material having a complex refractive index ñ′_{R}=n′_{R}−i*k′_{R} at the wavelength λ and having a thickness d′_{RG} in the groove portion and a thickness d′_{RL} in the portion between grooves, being present adjacent the substrate,
a further non-metallic layer of a substantially transparent material, being present adjacent the further write-once recording layer. The recording stack including the non-metallic reflective layer may be repeated in order to achieve a multi stack recordable medium. The use of the non-metallic layer is advantageous because a relatively high transmission is possible with a non-metallic reflective layer. Especially when using three or more recording stacks non-metallic layers are advantageous because of their relatively high optical transmission.

The substrate of the optical data storage medium is at least transparent for the radiation beam wavelength. For DVD the substrate is disk-shaped and has a diameter of 120 mm and a thickness of 0.6 mm and a further substrate with a thickness of 0.6 mm, the recording stack being sandwiched between the substrate and the further substrate. The guide groove is often constituted by a spiral-shaped groove and is formed in the substrate or further substrate by means of a mould during injection molding or pressing. These grooves can be alternatively formed in a replication process in a synthetic resin, for example a UV light-curable acrylate, which serves as the further substrate after curing.

Use of the optical data storage medium according to the invention in a standard optical data storage medium recording/reading device suitable for tracking by means of the push pull method onto a guide groove of a standard recordable optical data storage medium, which guide groove is present near a metallic reflective layer, has the advantage that no modification in the push-pull signal processing electronics of the recording/reading device is required. The push-pull signal will have a sufficient value.

The invention will be elucidated in greater detail with reference to the accompanying drawings, in which

FIG. 1 is a schematic layout of an optical storage medium according to the invention.

FIG. 2 is a schematic layout of an optical storage medium according to the invention having two recording stacks.

FIG. 3 shows the normalized push-pull of dye on a metallic (Ag) metallic reflective layer and on a dielectric (SiO₂) reflective layer versus groove depth g at λ=655 nm.

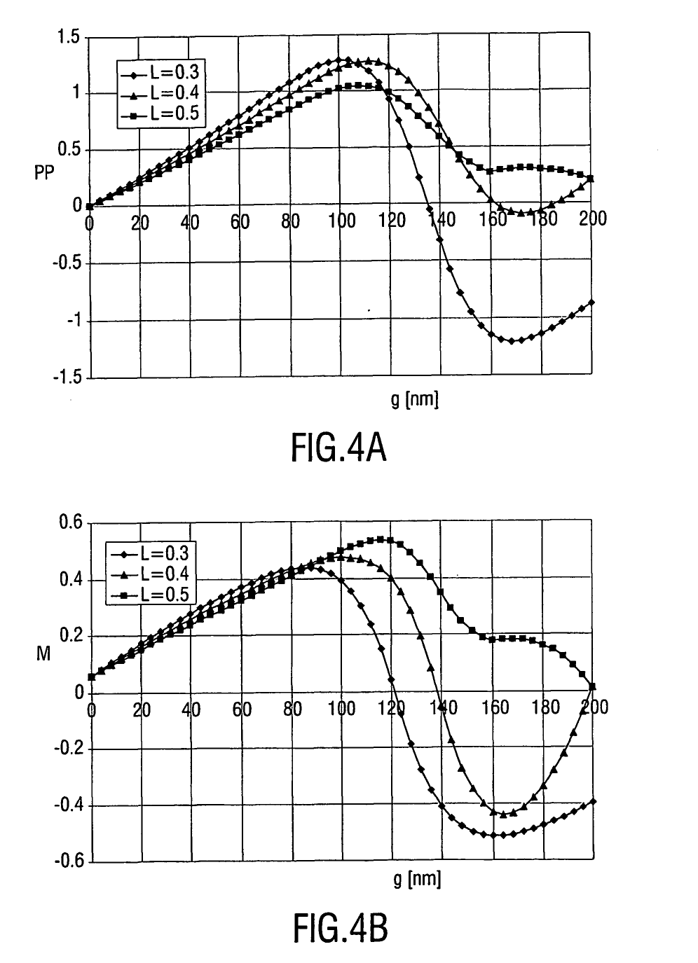

FIG. 4A shows the normalized push-pull PP for a 80 nm AZO-dye/110 nm SiO2 stack for three values of leveling L as a function of the groove depth g at λ=655 nm.

FIG. 4B shows the modulation M for a 80 nm AZO-dye/110 nm SiO2 stack for three values of leveling L as a function of the groove depth g at λ=655 nm.

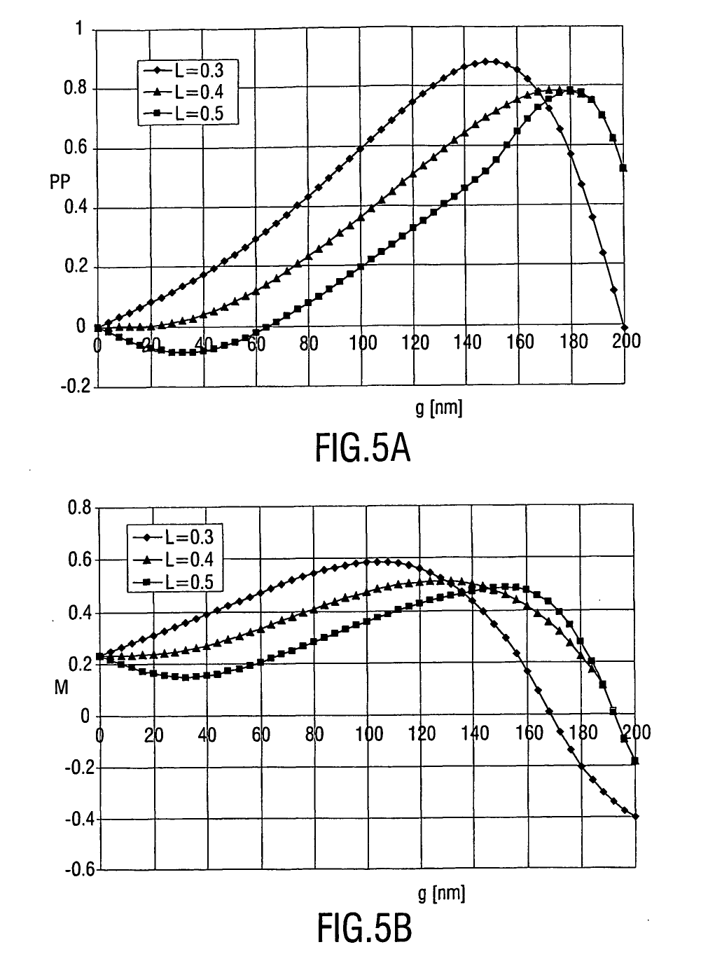

FIG. 5A shows the normalized push-pull PP for a 70 nm AZO-dye/52 nm SiC stack for three values of leveling L as a function of the groove depth g at λ=655 nm.

FIG. 5B shows the modulation M for a 70 nm AZO-dye/52 nm SiC stack for three values of leveling L as a function of the groove depth g at λ=655 nm.

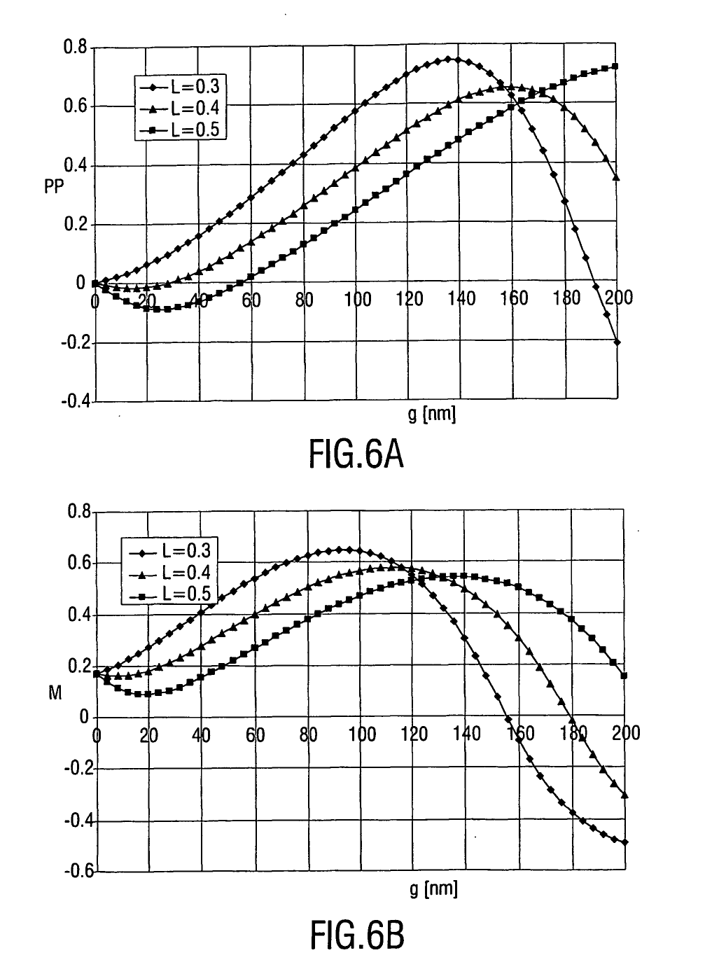

FIG. 6A shows the normalized push-pull PP for a 100 nm AZO-dye/10 nm a-Si stack for three values of leveling L as a function of the groove depth g at λ=655 nm.

FIG. 6B shows the modulation M for a 100 nm AZO-dye/10 nm a-Si stack for three values of leveling L as a function of the groove depth g at λ=655 nm.

In FIG. 1 a schematic cross section of an optical data storage medium 10, according to the invention, for recording by means of a focused radiation beam 9 is shown. The radiation beam is a laser beam and has a wavelength λ of approximately 655 nm and enters through an entrance face 8 of the medium during recording. The numerical aperture (NA) of the focused beam is 0.65. The medium comprises a substrate 1, including a guide groove with a depth g. The guide groove is present at the side of the substrate opposite to the entrance face 8. A recording stack 2, 3 of layers is present on the substrate 1 at the side of the guide groove. The recording stack includes a write once recording layer 2 of an azo dye having a complex refractive index ñ_{R}=2.45−i*0.08 at the wavelength and having a thickness d_{RG}=80 nm the groove portion and a thickness d_{RL}=32 nm in the portion between grooves, which corresponds to a leveling L=0.4. The write once recording layer 2 is present adjacent the substrate 1. Adjacent the write-once recording layer 2 a non-metallic layer 3 made of SiO₂ is present. The groove depth g=80 nm. A further substrate 4 is present adjacent the SiO₂ layer. The values of the normalized push-pull signal PP and the modulation M are 0.96 and 0.42 respectively, which values are sufficient for proper tracking and read out.

In FIG. 2 a schematic cross section of another embodiment of an optical data storage medium 20 according to the invention is shown. Reference numerals 1, 2, 3, 4, 8 and 9 denote the items as described with FIG. 1. A further recording stack 2′, 3′ is present adjacent the further substrate 4. The further recording stack 2′, 3′ may contain the same materials as the recording stack 2, 3.

In FIG. 3 the normalized push-pull signal PP of a dye on a metallic Ag reflective layer and on a dielectric SiO₂ reflective layer versus groove depth g are compared. The dye thickness in groove is 80 nm, levelling L=0.4, and the real part of the dye's refractive index is 2.3, λ=655 nm and NA=0.65. The normalized push-pull PP in case of a metallic or a dielectric reflective layer is substantially different. It is even more important that for the typical groove depth of 170 nm, used in single-layer DVD+R with metallic reflective layer, the normalized push-pull in the case of dye-on-dielectric stack is nearly zero and tracking on such a disk is practically impossible. In the following description of FIGS. 4A-6B the used wavelength λ=655 nm and NA=0.65.

In FIG. 4A the normalized push-pull PP for a 80 nm AZO-dye/110 nm SiO₂ stack for three values of leveling L as a function of the groove depth g is shown. Note that beyond g=125 nm the normalized push-pull value PP shows a decrease and becomes too low for proper tracking. The same holds for small values of g, e.g. <20 nm.

FIG. 4B shows the modulation M for a 80 nm AZO-dye/110 nm SiO₂ stack for three values of leveling L as a function of the groove depth g. The preferred groove depth g for this stack is 80 nm.

FIG. 5A shows the normalized push-pull PP for a 70 nm AZO-dye/52 nm SiC stack for three values of leveling L as a function of the groove depth g. It should noted that PP value stays at an acceptable level until about g=180 nm. However the modulation M tends to decrease at lower values of g. Hence a trade off is made between PP and M.

FIG. 5B shows the modulation M for a 70 nm AZO-dye/52 nm SiC stack for three values of leveling L as a function of the groove depth g. Note that beyond g=125 nm the modulation value shows a decrease and becomes too low for proper read out. The preferred groove depth g for this stack is 120 nm.

FIG. 6A shows the normalized push-pull PP for a 100 nm AZO-dye/10 nm a-Si stack for three values of leveling L as a function of the groove depth g.

FIG. 6B shows the modulation M for a 100 nm AZO-dye 10 nm a-Si stack for three values of leveling L as a function of the groove depth g. Note that beyond g=125 nm the modulation value M shows a decrease and becomes too low for proper read out. The preferred groove depth g for this stack is 120 nm.

It should be noted that the above-mentioned embodiments illustrate rather than limits the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

According to the invention an optical data storage medium for recording by means of a focused radiation beam having a wavelength λ is described. The beam enters through an entrance face of the medium during recording. The medium at least comprises a substrate, including a guide groove with a depth g. The guide groove is present at the side of the substrate opposite to the entrance face. A recording stack of layers is present adjacent the substrate at the side of the guide groove. The stack includes a write once recording layer of a material having a complex refractive index ñ_{R}=n_{R}−i*k_{R} at the wavelength λ and having a thickness d_{RG} in the groove portion and a thickness d_{RL} in the portion between grooves. A non-metallic layer of a substantially transparent material, is present adjacent the write-once recording layer. The groove depth g is in the range (λ/655)*20 nm<g<(λ/655)*140 nm with λ expressed in nm. This range achieves a sufficient push-pull tracking signal and a sufficient modulation of recorded marks.

1. An optical data storage medium (10) for recording by means of a focused radiation beam (9) having a wavelength λ and entering through an entrance face (8) of the medium during recording, at least comprising:
a substrate (1), including a guide groove with a depth g, the guide groove being present at the side of the substrate opposite to the entrance face (8),
a recording stack (2, 3) of layers on the substrate (1) at the side of the guide groove, which stack includes:
a write once recording layer (2) of a material having a complex refractive index ñ_{R}=n_{R}−i*k_{R} at the wavelength λ and having a thickness d_{RG} in the groove portion and a thickness d_{RL} in the portion between grooves, being present adjacent the substrate,
a non-metallic layer (3) of a substantially transparent material, being present adjacent the write-once recording layer (2),
characterized in that the groove depth g is in the range (λ/655)*20 nm<g<(λ/655)*140 nm with λ expressed in nm.

2. An optical data storage medium (10) as claimed in claim 1, wherein the non-metallic layer (3) mainly comprises a material selected from the group of transparent plastic, silicon, oxides of silicon, nitrides of silicon and carbides of silicon.

3. An optical data storage medium (10) as claimed in claims 1 or 2, wherein the wavelength λ is approximately 655 nm.

4. An optical data storage medium (10) as claimed in claim 3, wherein g<125 nm.

5. An optical data storage medium (10) as claimed in claims 3 or 4, wherein g>50 nm.

6. An optical data storage medium (10) as claimed in any one of claims 3-5, wherein the recording layer (2) has a thickness d_{RG} and 145 nm≦d_{RG}*n_{R}<245 nm and the non-metallic layer mainly comprises SiO₂ and has a thickness d_{T} in the range 5 nm≦d_{T}≦120 nm.

7. An optical data storage medium (10) as claimed in any one of claims 3-5, wherein the recording layer has a thickness d_{RG} and 132 nm≦d_{RG} *n_{R}<220 nm and the non-metallic layer mainly comprises SiC and has a thickness d_{T} in the range 5 nm≦d_{T}≦60 nm.

8. An optical data storage medium (10) as claimed in any one of claims 3-5, wherein the recording layer has a thickness d_{RG} and 154 nm≦d_{RG}*n_{R}<264 nm and the non-metallic layer mainly comprises amorphous Si and has a thickness d_{T} in the range 1 nm≦d_{T}≦20 nm.

9. An optical data storage medium (20) as claimed in any one of the preceding claims, wherein at least one further recording stack (2′, 3′) is present adjacent
a further substrate (4), including a guide groove with a depth g, in the same range as g, the guide groove being present at the side of the further substrate (4) opposite to the entrance face (8),
the further recording stack (2′, 3′) including:
a further write once recording layer (2′) of a material having a complex refractive index ñ′_{R}=n′_{R}−i*k′_{R} at the wavelength λ and having a thickness d′_{RG} in the groove portion and a thickness d′_{RL} in the portion between grooves, being present adjacent the substrate,
a further non-metallic layer (3′) of a substantially transparent material, being present adjacent the further write-once recording layer (2′).

10. Use of an optical data storage medium (10, 20) as claimed in any one of the preceding claims, in a standard optical data storage medium recording/reading device suitable for tracking by means of the push pull method onto a guide groove of a standard recordable optical data storage medium, which guide groove is present near a metallic reflective layer.
